(19) United States
(12) Patent Application Publication
(10) Pub. No.: US 2021/0247676 A1
(43) Pub. Date: Aug. 12, 2021

(54) LIGHT SOURCE APPARATUS AND IMAGE PROJECTION APPARATUS

(71) Applicant: CANON KABUSHIKI KAISHA, Tokyo (JP)

(72) Inventors: Yuya Kurata, Tochigi (JP); Ryota Kadowaki, Saitama (JP)

(21) Appl. No.: 17/167,357

(22) Filed: Feb. 4, 2021

(30) Foreign Application Priority Data
Feb. 7, 2020 (JP) 2020-019809
Feb. 3, 2021 (JP) 2021-015607

(51) Int. Cl. G03B 21/20; G03B 21/14; G02B 27/14

(52) U.S. Cl. CPC G03B 21/204; G02B 27/141; G03B 21/2013; G03B 21/142

(57) ABSTRACT

A light source apparatus includes a light source unit configured to emit light of a first wavelength, a first fluorescent element and a second fluorescent element each configured to convert at least part of the light of the first wavelength into light of a second wavelength that is different from the first wavelength, and a light amount adjustment unit configured to adjust an amount of light emitted to each of the first fluorescent element and the second fluorescent element. The first fluorescent element converts the light of the first wavelength into the light of the second wavelength at a first ratio. The second fluorescent element converts the light of the first wavelength into the light of the second wavelength at a second ratio that is different from the first ratio.

### BACKGROUND OF THE INVENTION

### Field of the Invention

The present invention relates to a light source apparatus and an image projection apparatus.

### Description of the Related Art

Conventionally, an image projection apparatus is known in which fluorescent light is generated by irradiating a fluorescent body with excitation light from a laser diode (LD), an illumination optical system guides illumination light including the fluorescent light to an optical modulation element, and a projection lens projects image light modulated by the light modulation element to display a color image. For example, an image projection apparatus is known that forms white light by combining blue light from a blue LD and yellow fluorescent light generated by the blue light as excitation light.

Japanese Patent Laid-Open No. (“JP”) 2018-21990 discloses an image projection apparatus that selects transmission and reflection of a polarization splitter by changing a polarization state of excitation light by using a phase difference plate, and adjusts a splitting ratio of light to be converted into fluorescent light and blue light to be used as the excitation light without conversion. JP 2012-178319 discloses an image projection apparatus that uses different fluorescent body, and generates white light by adjusting an intensity of excitation light emitted to each different fluorescent body.

However, part of light guided to a fluorescent body is diffusely reflected by the fluorescent body as non-converted light. An amount of the non-converted light correlates with an intensity of excitation light emitted to the fluorescent body, and the amount of non-converted light varies as the intensity of the excitation light varies. In the image projection apparatus disclosed in JP 2018-21990, since reflected non-converted light does not pass through the phase difference plate, a polarization state of the reflected non-converted light does not change, and thus the reflected non-converted light is reflected by a reflection element again into the fluorescent body and is not used. Further, a size of the image projection apparatus becomes large because a light path to perform color adjustment is required. In the image projection apparatus disclosed in JP 2012-178319, non-converted light is not used because the non-converted light becomes unintended colored light or is ultraviolet light that is invisible light. Thus, it is difficult for the image projection apparatus disclosed in each of JP2018-21990 and JP2012-178319 to adjust color of light from a light source while the light guided to the fluorescent body is effectively used.

### SUMMARY OF THE INVENTION

The present invention provides a light source apparatus and an image projection apparatus each of which can control a color variation in light from a light source caused by a variation in an intensity of excitation light, by using non-converted light in fluorescent body and increasing light use efficiency.

A light source apparatus according to one aspect of the present invention includes a light source unit configured to emit light of a first wavelength, a first fluorescent element and a second fluorescent element each configured to convert at least part of the light of the first wavelength into light of a second wavelength that is different from the first wavelength, and a light amount adjustment unit configured to adjust an amount of light emitted to each of the first fluorescent element and the second fluorescent element. The first fluorescent element converts the light of the first wavelength into the light of the second wavelength at a first ratio. The second fluorescent element converts the light of the first wavelength into the light of the second wavelength at a second ratio that is different from the first ratio.

A light source apparatus according to one aspect of the present invention includes a light source unit configured to emit light of a first wavelength, a collection optical system configured to collect the light of the first wavelength from the light source unit, a first fluorescent element and a second fluorescent element each configured to convert at least part of the light of the first wavelength collected by the collection optical system into light of a second wavelength that is different from the first wavelength, and a light amount adjustment unit configured to adjust an amount of light emitted to each of the first fluorescent element and the second fluorescent element. The collection optical system irradiates the first fluorescent element with the light of the first wavelength at a first light density, and irradiates the second fluorescent element with the light of the first wavelength at a second light density that is different from the first light density.

A light source apparatus according to one aspect of the present invention includes a light source unit configured to emit light of a first wavelength, a splitting unit configured to split the light from the light source unit, a fluorescent element configured to convert at least part of the light of the first wavelength into light of a second wavelength that is different from the first wavelength, a diffusion element configured to diffuse the light of the first wavelength, and a light amount adjustment unit configured to adjust an amount of light emitted to each of the fluorescent element and the diffusion element. The splitting unit irradiates each of the fluorescent element and the diffusion element with part of the light of the first wavelength from the light source unit at a first distribution ratio, and irradiates each of the fluorescent element and the diffusion element with at least part of remaining light of the first wavelength from the light source unit at a second distribution ratio that is different from the first distribution ratio.

An image projection apparatus including each of the above light source apparatuses also constitutes another aspect of the present invention.

Further features of the present invention will become apparent from the following description of exemplary embodiments with reference to the attached drawings.

### BRIEF DESCRIPTION OF THE DRAWINGS

FIG. 1 is a configuration diagram illustrating a light source apparatus according to a first embodiment.

FIG. 2 is a characteristic diagram of each fluorescent body according to the first embodiment.

FIG. 3 is a diagram illustrating a relationship between an irradiation intensity ratio and a B/G ratio according to the first embodiment.

FIG. 4 is a diagram illustrating a relationship between a luminance ratio and a ratio of current according to the first embodiment.

FIG. 5 is a characteristic diagram of each fluorescent body after control according to the first embodiment.

FIG. 6 is a configuration diagram illustrating an image projection apparatus according to the first embodiment.

FIG. 7 is a configuration diagram illustrating a light source apparatus according to a second embodiment.

FIG. 8 is a characteristic diagram of a fluorescent body according to the second embodiment.

FIG. 9 is a configuration diagram illustrating a light source apparatus according to a third embodiment.

FIG. 10 is a configuration diagram illustrating a light source apparatus according to a fourth embodiment.

FIG. 11 is a configuration diagram illustrating a light source apparatus according to a fifth embodiment.

### DESCRIPTION OF THE EMBODIMENTS

Referring now to the accompanying drawings, a detailed description will be given of embodiments according to the present invention.

### First Embodiment

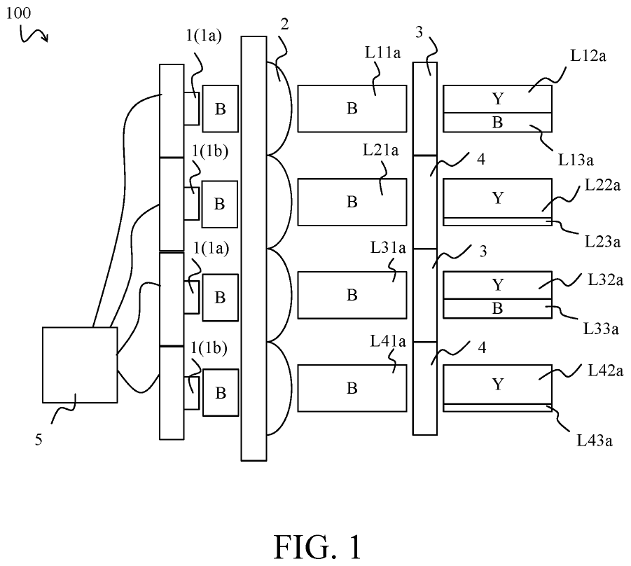

First, a description will be given of a light source apparatus according to a first embodiment of the present invention, with reference to FIG. 1. FIG. 1 is a configuration diagram illustrating a light source apparatus 100 according to this embodiment. In the following description, R, G, B, and Y represents red, green, blue, and yellow, respectively. The light source apparatus 100 includes a blue laser light source 1 as a light source unit, a first lens 2, a first fluorescent body 3 as a first fluorescent element, a second fluorescent body 4 as a second fluorescent element, and a control circuit 5 as a light amount adjustment unit.

The blue laser light source 1 is a laser diode (LD) that emits blue light. For example, 455 nm is a peak wavelength (first wavelength) of light emitted from the blue laser light source 1. The blue laser light from the blue laser light source 1 is emitted to the first lens 2. The first lens 2 is an optical system configured to irradiate the first fluorescent body 3 and the second fluorescent body 4 with the light from the blue laser light source 1. B and Y described in rectangular areas in FIG. 1 indicate distribution of intensities in light between each element. A reference numeral with L prefix is added to each rectangular area for easy understanding for each feature, and will be used later in the following explanation. This is the same in the following drawings.

The light emitted from the first lens 2 is emitted as excitation light. The excitation light is emitted to the first fluorescent body 3 and the second fluorescent body 4 which are arranged alternately. Of the excitation light emitted to the first fluorescent body 3 and the second fluorescent body 4, part of the light is converted to fluorescent light of a second wavelength, and remaining light is emitted as light of a same wave length as the excitation light which is also referred to as a first wavelength hereinafter. The control circuit 5 is configured to adjust luminance and color by independently adjusting output to each of a first light source 1a that irradiates the first fluorescent body 3 and the second light source 1b that irradiates the second fluorescent body 4. For example, the control circuit 5 adjusts an amount of light emitted to each of the first fluorescent body 3 and the second fluorescent body 4 by controlling a value of current to each of the first light source la and the second light source 1b.

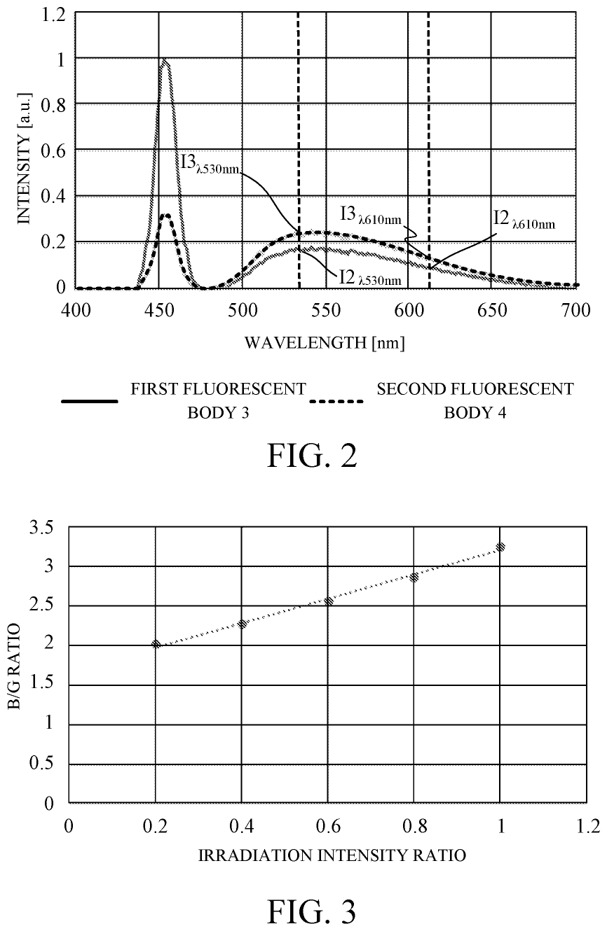

Next, a description will be given of characteristics of the first fluorescent body 3 and the second fluorescent body 4 with reference to FIG. 2. FIG. 2 is a characteristic diagram of the first fluorescent body 3 and the second fluorescent body 4. In FIG. 2, a horizontal axis represents wavelength (nm) and a vertical axis represents light-emitting intensity. In a wavelength band of 440 nm to 470 nm of the light that excites each fluorescent body, when peak intensities are compared, the peak intensity of the first fluorescent body 3 is higher than the peak intensity of the second fluorescent body 4. On the other hand, in a wave length band of 490 nm to 700 nm of the fluorescent light, when peak intensities are compared, the peak intensity of the first fluorescent body 3 is lower than the peak intensity of the second fluorescent body 4.

The first fluorescent body 3 and the second fluorescent body 4 are made of substantially same material. When, in a light emission characteristic of the first fluorescent body 3, I2_{λ530 nm} represents an intensity of light of 530 nm wavelength and I_{2λ610 nm} represents an intensity of light of 610 nm wavelength, and in a light emission characteristic of the second fluorescent body 4, I3_{λ530 nm} represents an intensity of light of 530 nm and I3_{λ610 nm} represents an intensity of light of the wavelength of 610 nm, the value of (I2_{λ530 nm}/I2_{λ610 nm})/(I3_{λ530 nm}/I3_{λ610 nm}) is in a range of 0.8 to 1.2.

A description will be given of the characteristic of the fluorescent bodies according to this embodiment with reference to FIG. 2. The first fluorescent body 3 and the second fluorescent body 4 are fluorescent bodies made of the same YAG Ce fluorescent material. In FIG. 2, I2_{λ530 nm} is 0.17 and I2_{λ610 nm} is 0.10, of the first fluorescent body 3. I3_{λ530 nm} is 0.24 and I3_{λ610 nm} is 0.14, of the second fluorescent body 4. The value of (I2_{530 nm}/I2_{λ610 nm})/(I3_{λ530 nm}/I3_{λ610 nm}) is 0.99, and if the same fluorescent material is used, the value is close to 1.0.

A difference in the characteristics between the first fluorescent body 3 and the second fluorescent body 4 can be made by forming the fluorescent bodies made of the same material in different thicknesses, for example, by making the first fluorescent body 3 thin (˜80 μm) and the second fluorescent body 4 thick (˜120 μm). Here, the thickness of the fluorescent body is a thickness of fluorescent member, and is a thickness of a light emitting portion of each fluorescent body when each fluorescent body is formed by laminating binder mixed with fluorescent member on a substrate such as an A1 substrate or a sapphire substrate. A ratio of the intensity here is an example, and the present invention can be variously applied as long as the relationships between the intensities are satisfied in the wavelength band of the excitation light and in the wavelength band of the fluorescent light.

In this embodiment, each of the first fluorescent body 3 and the second fluorescent body 4 may include fluorescent material and diffusion material (microparticles such as titanium oxide and barium sulfate). The fluorescent material is the same in the first fluorescent body 3 and the second fluorescent body 4. The configuration is not limited to the configuration in which thicknesses are different between the first fluorescent body 3 and the second fluorescent body 4, and may be a configuration in which concentrations of the fluorescent material, that is filling rates of the fluorescent material, or mixing ratios of the diffusion material are different between the first fluorescent body 3 and the second fluorescent body 4.

Next, a description will be given of light emitted to each fluorescent body. In this embodiment, the first fluorescent body 3 and the second fluorescent body 4 are irradiated with four beams of excitation light L11a, L21a, L31a, and L41a, but the present invention is not limited to this.

The blue excitation light L11a is emitted to the first fluorescent body 3. The first fluorescent body 3 converts the excitation light L11a into fluorescent light Y at a ratio illustrated in FIG. 2, that is a first ratio, and emits fluorescent light L12a. Part of the excitation light emitted to the first fluorescent body 3 becomes blue excitation light L13a as non-converted light. Similarly, the blue excitation light L21a is emitted to the second fluorescent body 4. The second fluorescent body 4 converts the excitation light L21 a into fluorescent light Y at a ratio illustrated in FIG. 2, which is also referred to as a second ratio hereinafter, and emits fluorescent light L22a. Part of the light emitted to the second fluorescent body 4 becomes blue excitation light L23a as non-converted light. By a similar action as that on the excitation light L11a, the excitation light L31a is emitted as fluorescent light L32a and excitation light L33a from the first fluorescent body 3. By a similar action as that on the excitation light L21a, the excitation light L41a is emitted as fluorescent light L42a and excitation light L43a from the second fluorescent body 4. According to the above-described actions, it is possible to obtain emitted light from light source in which a ratio of excitation light is high when light is emitted via the first fluorescent body 3 and in which a ratio of excitation light is low when light is emitted via the second fluorescent body 4.

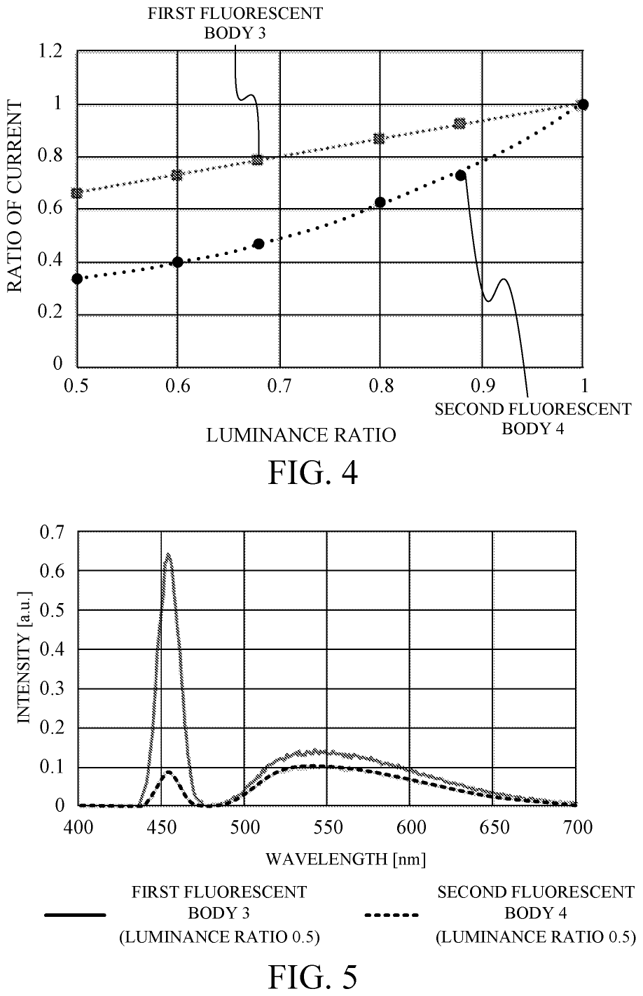

Next, control by the control circuit 5 will be described with reference to FIGS. 3 and 4. FIG. 3 is a diagram illustrating a change in a ratio of the fluorescent light Y and non-converted light B emitted from the fluorescent bodies when each output of the excitation light changes. In FIG. 3, a horizontal axis represents an irradiation intensity ratio, and a vertical axis represents a B/G ratio when the irradiation intensity changes. A conversion efficiency in each fluorescent body has a characteristic that the conversion efficiency is high When an intensity of excitation light is low. Thus, when the output of the excitation light is controlled to be reduced, the ratio of the fluorescent light Y increases and a color ratio changes, that is, the B/G ratio decreases.

The control circuit 5 is configured to control the output of the excitation light so that color of light emitted from the light source is maintained when each output of the excitation light changes. In each, of the first fluorescent body 3 and the second fluorescent body 4, the ratio of the fluorescent light increases when the output of excitation light decreases. In the first fluorescent body 3, an increase amount of unit output of the fluorescent light is smaller than that in the second fluorescent body 4 because the ratio of the fluorescent light is originally low. That is, by relatively increasing the ratio of output to the first fluorescent body 3, the ratio of the fluorescent light to whole light can be maintained.

FIG. 4 illustrates a ratio of the output of the excitation light emitted to the first fluorescent body 3 and the second fluorescent body 4 when a predetermined luminance is achieved. In FIG. 4, a horizontal axis represents luminance (luminance ratio) to be achieved, and a vertical axis represents a ratio of current in each light source, the current being controlled by the control circuit 5. The ratio of current is a value that sets, as a standard, current for achieving maximum luminance in each series of the first fluorescent body 3 and the second fluorescent body 4. When the luminance is to be reduced, control is provided so that the output to the second fluorescent body 4 is preferentially lowered, and so that a ratio of the output to the second fluorescent body to whole output decreases. Specifically, when the luminance ratio is 1, the first fluorescent body 3 and the second fluorescent body 4 are irradiated with the excitation light from each light source at a ratio of current of 1:1, that is, with the current of the same amount. When the luminance ratio is 0.5, current is reduced while a relative difference is given so that the ratio of current becomes 0.66:0.33, i.e., the ratio of current to the first fluorescent body 3 is twice that of the second fluorescent body 4.

Next, a description will be given of characteristics of the first fluorescent body 3 and the second fluorescent body 4 after control according to this embodiment, with reference to FIG. 5. FIG. 5 is a characteristic diagram of the first fluorescent body 3 and the second fluorescent body 4 after control. In FIG. 5, a horizontal axis represents wavelength (nm) and a vertical axis represents intensity. FIG. 5 indicates a light-emission intensity of the first fluorescent body 3 and the second fluorescent body 4 when the luminance ratio is 0.5. For easy comparison, an absolute value of the intensity is standardized is in FIG. 2 in which the intensity of the excitation light of the first fluorescent body 3 is set to 1. Since the luminance is lowered, the intensity of the excitation light decreases to about 0.6 even in the first fluorescent body 3. Since the ratio of the fluorescent light increases, the output from the second fluorescent body 4 decreases significantly as compared with the output from the first fluorescent body 3. The B/G ratio decreases from 5.4 to 4.5 in the first fluorescent body 3, and from 1.3 to 0.8 in the second fluorescent body 4. Since the ratio of output from the first fluorescent body 3 is relatively high, overall B/G ratio maintains an initial state. As described above, the first, fluorescent body 3 and the second fluorescent body 4 of different ratios are prepared in advance, and when the output changes, the control circuit 5 controls irradiation intensities to the fluorescent bodies at different ratios. Thereby, it is possible to realize a light source unit that keeps the same color when the output changes.

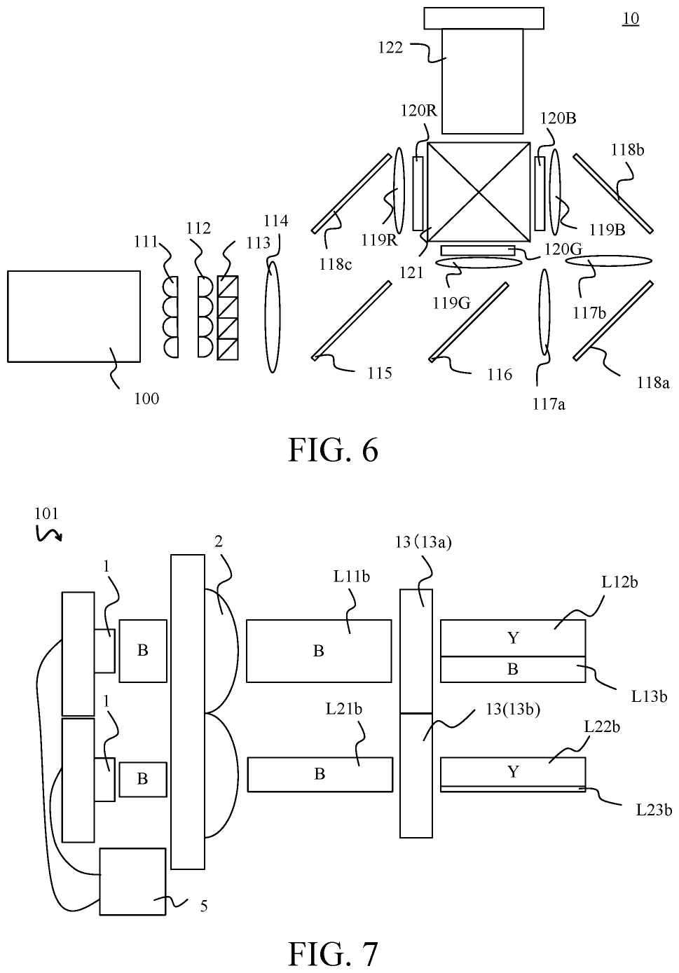

Next, a description will be given of a projector 10 as an image projection apparatus including the light source apparatus 100 with reference to FIG. 6. FIG. 6 is a block diagram illustrating the projector 10. A reference numeral 111 denotes a first fly-eye lens, a reference numeral 112 denotes a second fly-eye lens, a reference numeral 113 denotes a polarizing beam splitter, a reference numeral 114 denotes a light-entering side condenser lens, a reference numeral 115 denotes a first dichroic mirror, and a reference numeral 116 denotes a second dichroic mirror. Reference numerals 117a and 117b denote relay lenses, and reference numerals 118a, 118b and 118c denote reflection mirrors. A reference numeral 1198 denotes a condenser lens for R, a reference numeral 119G denotes a condenser lens for G, and a reference numeral 119B denotes a condenser lens for B. A reference numeral 120R denotes a transmission-type liquid crystal display element for R, a reference numeral 120G denotes a transmission-type liquid crystal display element for G, and a reference numeral 120B denotes a transmission-type liquid crystal display element for B. A reference numeral 121 denotes a cross dichroic prism and a reference numeral 122 denotes a projection lens.

Light emitted from the light source apparatus 100 is split into split light beams by the first fly-eye lens 111 and the second fly-eye lens 112, and enters the polarization conversion element 113. The light is unified into light of a specific polarization by the polarization conversion element 113, and is guided to the first dichroic mirror 115 in the light-entering side condenser lens 114. The first dichroic mirror 115 has a characteristic of reflecting R and transmitting G and B, and splits light for each color. The light reflected by the first dichroic mirror 115 is reflected by the reflection mirror 118c and guided to the transmission-type liquid crystal display element 120R for R via the condenser lens 119R for R. Each light of G and B transmitted through the first dichroic mirror 115 is guided to the second dichroic mirror 116. The second dichroic mirror 116 has a characteristic that reflects G and transmits B, and splits light for each color. The light reflected by the second dichroic mirror 116 is guided to the transmission-type liquid crystal display element 120G for G via the condenser lens 119E for G. The light transmitted by the second dichroic mirror 116 is guided to the transmission-type liquid crystal display element 120B for B via the relay lenses 117a and 117b, the reflection mirrors 118a and 118b, and the condenser lens 119B for B.

Each of the transmission-type liquid crystal display elements (light modulation elements) 120R, 120G and 120B for each color (RGB) is provided with polarizing plates on a light-entering side and on a light-emitting side, and a transmission amount changes according to a polarization state, Each of the transmission-type liquid crystal display elements 120R, 120G, and 120B is configured to control the transmission amount by changing the state of the liquid crystal by electrical control. The light transmitted through the transmission-type liquid crystal display elements 120R, 120G and 120B for each color is guided by the cross dichroic prism Where G is transmitted and R and B are reflected on different slopes, to the projection lens 122, and projected onto a projection surface such as a screen which is not illustrated. In each embodiment, a transmission-type liquid crystal panel is used as an optical modulation element, but a reflection-type liquid crystal panel or a digital micromirror device (DMD) may be used.

As described above, in this embodiment, the first fluorescent body 3 converts the light of the first wavelength from the blue laser light source 1 into the light of the second wavelength at the first ratio, and the second fluorescent body 4 converts the light of the first wavelength from the blue laser light source 1 into the second wavelength at the second ratio that is different from the first ratio. The first ratio may be smaller than thee second ratio, and the control circuit 5 may adjust the amounts of light so that a first amount of light emitted to the first fluorescent body 3 is larger than a second amount of light emitted to the second fluorescent body 4. However, this embodiment is not limited to this.

This embodiment controls the irradiation light at different ratios (first ratio, second ratio) to two different types of fluorescent bodies (first fluorescent body 3, second fluorescent body 4). Thereby, it is possible to obtain white light with little change even when luminance changes.

### Second Embodiment

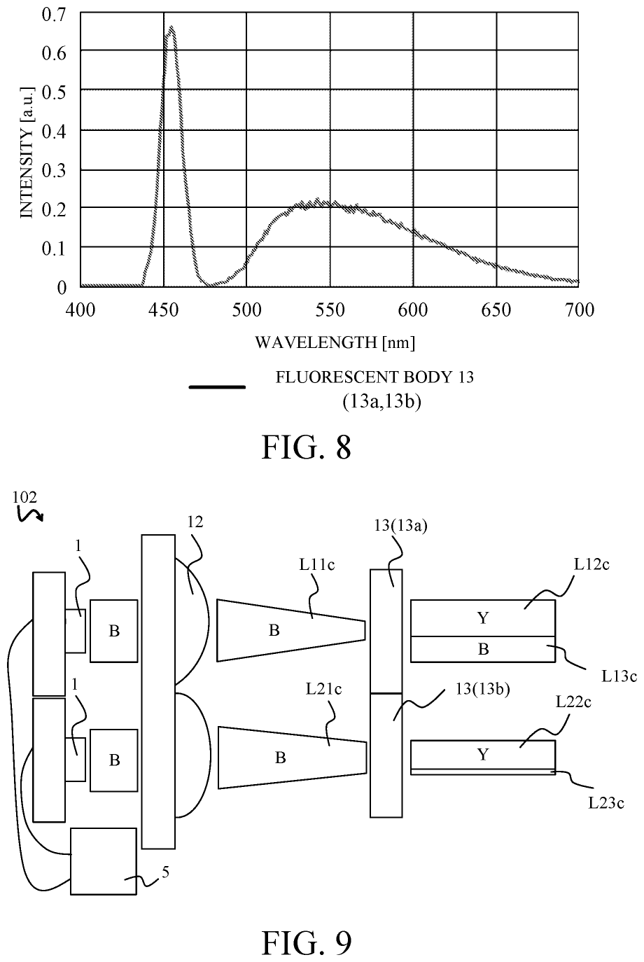

Next, a description will be given of a light source apparatus according to a second embodiment of the present invention with reference to FIGS. 7 and 8. FIG. 7 is a block diagram illustrating a light source apparatus 101 according to this embodiment. FIG. 8 is a characteristic diagram of fluorescent bodies 13 (first fluorescent body 13a, second fluorescent body 13b) provided in the light source apparatus 101. In FIG. 8, a horizontal axis represents wavelength (nm) and a vertical axis represents light intensity. In this embodiment, configurations of a projector other than the light source apparatus are the same as those of the projector 10 according to the first embodiment, and thus the description thereof wilt be omitted.

The light source apparatus 101 according, to this embodiment includes a first lens 2 as a collection optical system configured to collect light of a first wavelength from a blue laser light source 1. The first lens 2 irradiates the first fluorescent body 13a with the light of the first wavelength light from the blue laser light source I with a first light density (excitation light L11b), and irradiates the second fluorescent body 13b with the light of the first wavelength light from the blue laser light source with a second light density (excitation light L21b) that is different from the first light density. The first fluorescent body 13a and the second fluorescent body 13b are the fluorescent bodies 13 and have the same characteristics. In FIG. 7, the number of light sources is reduced to two as compared with the light source apparatus 100 of FIG. 1, but the other configurations are the same, and thus the description thereof will be omitted.

A description will be given of light emitted to each of the first fluorescent body 13a and the second fluorescent body 13b. In this embodiment, the first fluorescent body 13a and the second fluorescent body 13b are irradiated with the excitation light L11b and the excitation light L21b, respectively. The blue excitation light L11b is emitted to the first fluorescent body 13a with the first light density. Similarly, the blue excitation light L21b is emitted to the second fluorescent body 13b disposed on a position different from that of the first fluorescent body 13a, with the second light density that is different from the first light density of the excitation light L11b. In this embodiment, the first fluorescent body 13a and the second fluorescent body 13b convert the excitation light to fluorescent light Y at a ratio indicated in FIG. 8. In this embodiment, a case will be described in which the second light density of the excitation light L21b is lower than the first light density of the excitation light L11b.

As described in the first embodiment, conversion efficiencies of the fluorescent bodies 13 vary according to the irradiation intensities, and when each irradiation intensity is weak, each conversion efficiency becomes high. The converted light is emitted as fluorescent light L22b. Part of the light emitted to the fluorescent bodies 13 becomes excitation light L23b as non-convened blue light. Output (light density) of the excitation light L21b is lower than that of the excitation light L11b, therefore, in a ratio of the converted fluorescent fight L22b and the non-converted blue excitation light L23b, a ratio of the fluorescent light Y is higher than that in a ratio of the fluorescent light L12b converted from the excitation light L11b and the unconverted blue excitation light L13b. That is, in this embodiment, the second light density is smaller than the first light density, and a control circuit 5 as a light amount adjustment unit adjusts amounts of light so that a first amount of light emitted to the first fluorescent body 13a is larger than a second amount of light emitted to the second fluorescent body 13b. However, this embodiment is not limited to this.

According to the above-described action, while a plurality of fluorescent bodies 13 having the same characteristics are used, it is possible to acquire light emission of a light source where a ratio of excitation light is high on a side of the light source with a large amount of excitation light, and a ratio of excitation light is low on a side of the light source with a small amount of excitation light. Operation of the control circuit 5 is the same as that of the first embodiment. When lowering luminance, the control circuit 5 first lowers the output of the excitation light L21b from which excitation light of at lower ratio is generated so as to lower a ratio of the excitation light L21b to whole output. Thereby, the light source can maintain the same color even when the output changes.

### Third Embodiment

Next, a description will be given of a light source apparatus according to the third embodiment of the present invention with reference to FIG. 9. FIG. 9 is a block diagram illustrating a light source apparatus 102 according to this embodiment. In this embodiment, configurations of a projector other than the light source apparatus are the same as those of the projector 10 according to the first embodiment, and thus the description thereof will be omitted.

The light source apparatus 102 according to this embodiment includes a second lens (collection optical system) 12 configured to collect light of first wavelength from a blue laser light source 1. The second lens 12 is an optical system for irradiating a first fluorescent body 13a and a second fluorescent body 13b with light from a blue laser light source 1 at different light densities, and can be realized by, for example, changing curvature of the second lens 12. The second lens 12 irradiates the first fluorescent body 13a with light of the first wavelength from the blue laser light source 1 with the first light density (excitation light L11c), and irradiates the second fluorescent body 13b with light of the first wavelength from the blue laser light source 1 with the second light density (excitation light L21c) that is different from the first light density. The first fluorescent body 13a and the second fluorescent body 13b are fluorescent bodies 13 and have the same characteristics.

A description will be given of the light emitted to each of the first fluorescent body 13a and the second fluorescent body 13b. In this embodiment, the first fluorescent body 13a and the second fluorescent body 13b are irradiated with the excitation light L11c and the excitation light 121c, respectively. The blue excitation light L11c is emitted to the first fluorescent body 13a with the first light density. Similarly, the blue excitation light L21c is emitted, to the second fluorescent body 13b disposed on a position different from that of the first fluorescent body 13a with the second light density that is different from the first light density of the excitation light L11c. In this embodiment, the first fluorescent body 13a and the second fluorescent body 13b convert the excitation light to fluorescent light Y at a ratio illustrated in FIG. 8. In this embodiment, a case will be described in which the second light density of the excitation light L21c is lower than the first light density of the excitation light L11c.

When irradiation densities are different, efficiencies are different as in the state described in the first embodiment where the conversion efficiencies of the fluorescent bodies are different when the amounts of irradiation light are different, The converted light is emitted as fluorescent light L22c. Part of the light emitted to the fluorescent bodies 13 becomes excitation light L23c as non-converted blue light. Light density of the excitation light L21c is lower than that of the excitation light L11c. Thus, in a ratio of the converted fluorescent light L22c and the non-converted blue excitation light L23c, a ratio of the fluorescent light Y is higher than that in a ratio of the fluorescent light L12c converted from the excitation light L11c and the unconverted blue excitation light L13c That is, in this embodiment, the second light density is smaller than the first light density, and a control circuit 5 as a light amount adjustment unit adjusts amounts of light so that a first amount of light emitted to the first fluorescent body 13a is larger than a second amount of light emitted to the second fluorescent body 13b. However, this embodiment is not limited to this.

According to the above-described action, while a plurality of fluorescent bodies 13 having the same characteristics are used, it is possible to acquire light emission of a light source where a ratio of excitation light is high on a side of the light source with high excitation light density, and a ratio of excitation light is low on a side of the light source with low excitation light density. The operation of the control circuit 5 is the same as that of the first embodiment or the second embodiment. When lowering luminance, the control circuit 5 first lowers output of the excitation light L21c from which excitation light of a lower ratio is generated, so as to lower a ratio of the excitation light L21c to whole output. Thereby, the light source can maintain the same color even when the output changes.

### Fourth Embodiment

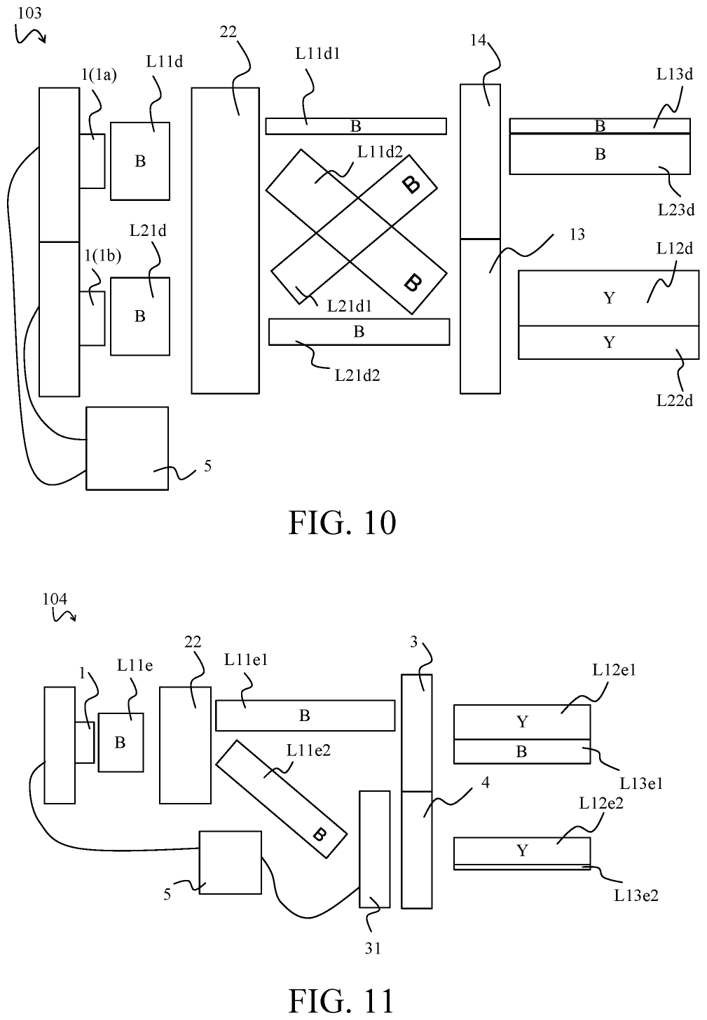

Next, a description will be given of a light source apparatus according to a fourth embodiment of the present invention with reference to FIG. 10. FIG. 10 is a block diagram illustrating a light source apparatus 103 according to this embodiment. In this embodiment, configurations of a projector other than the light source apparatus are the same as those of the projector 10 according to the first embodiment, and thus the description thereof will be omitted.

The light source apparatus 103 according to this embodiment includes a splitting optical element (splitting unit) 22 configured to split light from a blue laser light source 1, a fluorescent body 13 configured to convert at least part of light of a first wavelength into light of a second wavelength that is different from the first wavelength, and a diffusion plate 14 configured to diffuse the light of the first wavelength. The fluorescent body 13 and the diffusion plate 14 are disposed on different positions from each other. A control circuit 5 as a light amount adjustment unit is configured to adjust an amount of light emitted to each of the fluorescent body 13 and the diffusion plate 14.

The blue laser light emitted from the blue, laser light source 1 is emitted to the splitting optical element 22. The splitting optical element 22 is formed of CGH (Computer-Generated Hologram) or the like, but is not limited thereto. The splitting optical element 22 mixes and splits the emitted light from a first light source la and a second light source 1b, and irradiates the fluorescent body 13 and the diffusion plate 14, respectively. The splitting optical element 22 irradiates the fluorescent body 13 and the diffusion plate 14 with part of the light (L11d) of the first wavelength from the blue laser light source 1 at a first distribution ratio (excitation light L11d1, L11d2). The splitting optical element 22 irradiates the fluorescent body 13 and the diffusion plate 14 with at least part of remaining light (L21d) of the first wavelength from the blue laser light source 1 at a second distribution ratio (excitation light L21d1, L21d2) that is different from the first distribution ratio.

Here, a description will be given of the light emitted to each of the fluorescent body 13 and the diffusion plate 14. In this embodiment, an example will be described where two beams of excitation light L11d and L21d is emitted to each of the fluorescent body 13 and the diffusion plate 14. The excitation light L11d is split into excitation light L11d1 and excitation light L11d2 by the splitting optical element 22. The excitation light L11d1 is emitted to the diffusion plate 14. The excitation light L11d2 is emitted to the fluorescent body 13. The excitation light L21d is split into excitation light L21d1 and excitation light L21d2 by the splitting optical element 22. The excitation light L21d1 is emitted to the diffusion plate 14. The excitation light L21d2 is emitted to the fluorescent body 13.

The splitting optical element 22 splits the light at a ratio such that in the light emitted to the diffusion plate 14, a ratio of the excitation light L11d1 is smaller than a ratio of the excitation light L21d1. The excitation light L11d1 and the excitation light L21d1 are used as excitation light L13d and excitation light L23d without being fluorescently converted because those are emitted to the diffusion plate 14. Thus, the excitation light to be used includes the light based on the excitation light L21d at a larger ratio. On the other hand, the splitting optical element 22 splits the light at a ratio such that in the light emitted to the fluorescent body 13, a ratio of the excitation light L11d2 is larger than a ratio of the excitation light L21d2. The excitation light L11d2 and the excitation light L21d2 are fluorescently converted and used as fluorescent light L12d and fluorescent light L22d because those are emitted to the fluorescent body 13. Thus, the fluorescent light to be used includes light based on the excitation light L11d at a larger ratio. That is, in this embodiment, a control circuit 5 adjusts an amount of light so that among the light split by the splitting optical element 22, the light split at the first distribution ratio is larger than the light split at the second distribution ratio.

According to the above-described action, when light is emitted from the light source apparatus 103, a combination of the fluorescent light L12d and the excitation light L13d which are based on the excitation light L11d includes higher ratio of fluorescent light than that of a combination of the fluorescent light L22d and the excitation light L23d which are based on the excitation light L21d, The operation of the control circuit 5 is the same as that in the first embodiment or the second embodiment. When lowering luminance, the control circuit 5 first lowers output of excitation light L21d from which excitation light of a lower ratio of is generated, so as to lower a ratio of the excitation light L21d to whole output. Thereby, the light source can maintain the same color even when the output changes.

### Fifth Embodiment

Next, a description will be given of a light source apparatus according to a fifth embodiment of the present invention with reference to FIG. 11 FIG. 11 is a configuration diagram illustrating a light source apparatus 104 according to this embodiment. In this embodiment, configurations of a projector other than the light source apparatus are the same as those of the projector 10 according to the first embodiment, and thus the description thereof will be omitted.

The light source apparatus 104 according to this embodiment includes a splitting optical element (splitting unit) 22 configured to split light of a first wavelength from a blue laser light source 1, and an amplitude modulation element 31 configured to control transmittance or reflectance of the light of the first wavelength split by the splitting optical element 22, that is, to reduce output of light. The amplitude modulation element 31 is disposed between the blue laser light source 1 and at least one of a first fluorescent body 3 and a second fluorescent body 4.

The blue laser light emitted from the blue laser light source 1 is emitted to the splitting optical element 22. The splitting optical element 22 is formed of CGH (Computer-Generated Hologram) or the like, but is not limited thereto. The splitting optical element 22 splits the light emitted from the blue laser light source 1 and irradiates the first fluorescent body 3 and the second fluorescent body 4, respectively, In this embodiment, the amplitude modulation element 31 is disposed between the splitting optical element 22 and the second fluorescent body 4. The amplitude modulation element 31 can adjust the output from the blue laser light source 1 and irradiate the second fluorescent body 4. In this embodiment, the amplitude modulation element 31 may be disposed between the splitting optical element 22 and the first fluorescent body 3 or may be disposed between the splitting, optical element 22 and each of the first fluorescent body 3 and the second fluorescent body 4, that is, disposed at each position corresponding to each of the first fluorescent body 3 and the second fluorescent body 4.

Here, a description will be given of light emitted to each of the first fluorescent body 3 and the second fluorescent body 4. In this embodiment, an example will be described in which one excitation light L11e is emitted to the first fluorescent body 3 and the second fluorescent body 4. The excitation light L11e is split into excitation light L11e1 and excitation light L11e2 by the splitting optical element 22. The excitation light L11e1 is emitted to the first fluorescent body 3. The excitation light L11e2 is emitted to the second fluorescent body 4 via the amplitude modulation element 31. The excitation light L11e1 emitted to the first fluorescent body 3 becomes fluorescent-converted fluorescent light L11e1 and non-converted light L13e1. The excitation light L11e2 emitted to the second fluorescent body 4 becomes fluorescent-converted fluorescent light L12e2 and non-converted light L13e2.

According to above-described action, when the light source apparatus 104 emits light, in a case where the output is not adjusted by the amplitude modulation element 31, the light emitted via the first fluorescent body 3 includes excitation light at a high ratio and the light emitted via the second fluorescent body 4 includes excitation light at a low ratio, based on the characteristics of the first fluorescent body 3 and the second fluorescent body 4. When lowering luminance, the control circuit 5 lowers, to whole output, a ratio of output to the second fluorescent body 4 that generates excitation light at a lower ratio, as the output of the blue laser light source 1 lowers. Thereby, the light source can maintain the same color even when the output changes.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory compute readable storage medium’) to perform the functions of one or more of the above-described embodiment(s) and/or that includes one or more circuits (e.g., application specific integrated circuit (ASIC) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions ma be provided to the computer, for example, from a network or the storage medium, The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory, card, and the like.

Each of above-described embodiments has a configuration including the fluorescent body and/or the diffusion plate each of which transmits the blue laser, but may have a configuration of a reflective type. In that case, a balance between non-convened light and fluorescent light may be adjusted by adjusting an amount of the diffusion element to be included. Although the laser light source is used as the blue light source, an LED light source may also be used. In each of the above-described embodiments, an irradiation position of the fluorescent body does not change, but a system may be used such that the irradiation position changes while the fluorescent body disposed in an annular shape rotates. The above-described embodiments include one to four light sources, but may be applied to a case such that each block is unitized and more light sources are included. The number of light source blocks corresponding to the characteristics is not limited to one to four, as long as at least two characteristics are realized at the time of light emission from the light source apparatus.

According to each embodiment, it is possible to provide a light source apparatus and an image projection apparatus each of which can control a color variation in light from a light source caused by a variation in an intensity of excitation light, by using non-converted light in fluorescent body and increasing light use efficiency.

While, the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2020-019809, filed on February 7, 2020 and 2021-015(07, tiled on February 3, 2021 which are hereby incorporated by reference herein in their entirety.

What is claimed is:

1. A light source apparatus comprising:
a light source unit configured to emit light of a first wavelength;
a first fluorescent element and a second fluorescent element each configured to convert at least part of the light of the first wavelength into light of a second wavelength that is different from the first wavelength; and
a light amount adjustment unit configured to adjust an amount of light emitted to each of the first fluorescent element and the second fluorescent element,
wherein the first fluorescent element converts the light of the first wavelength into the light of the second wavelength at a first ratio, and
wherein the second fluorescent element converts the light of the first wavelength into the light of the second wavelength at a second ratio that is different from the first ratio.

2. The light source apparatus according to claim 1,
wherein the first ratio is smaller than the second ratio, and
wherein the light amount adjustment unit adjusts the amount of light so that a first amount of light emitted to the first fluorescent element is larger than a second amount of light emitted to the second fluorescent element.

3. The light source apparatus according to claim 1,
wherein the light source unit includes a first light source and a second light source each of which emits tight of the first wavelength, and
wherein the light amount adjustment unit adjusts the amount of light emitted to each of the first fluorescent element and the second fluorescent element by controlling values of current to the first light source and the second light source.

4. The light source apparatus according to claim 1, further comprising:
a splitting unit configured to split the light of the first wavelength from the light source unit: and
an amplitude modulation unit configured to control transmittance or reflectance of the light of the first wavelength split by the splitting unit,
wherein the amplitude modulation unit is disposed between the light source unit and at least one of the first fluorescent element and the second fluorescent element.

5. The light source apparatus according to claim 1,
wherein the first fluorescent element and the second fluorescent element respectively include fluorescent material and diffusion material,
wherein the fluorescent material is the same in each of the first fluorescent element and the second fluorescent element, and
wherein at least one of a concentration and a thickness of the fluorescent material and a mixing ratio of the diffusion material is different between the first fluorescent element and the second fluorescent element.

6. The light source apparatus according to claim 1,
wherein when in the light of the second wavelength acquired by conversion at a first ratio in the first fluorescent element, I2_{λ530 nm} represents an intensity of light of 530 nm, and I2_{λ610 nm} represents an intensity of light of 610 nm, and in the light of the second wavelength acquired by conversion at a second ratio in the second fluorescent element, I3_{λ530 nm} represents an intensity of light of 530 nm, and I3_{λ610 nm} represents an intensity of light of 610 nm, a value of (I2_{λ530 nm}/I2_{λ610 nm})/(I3_{λ530 nm}/I3_{λ610 nm}) is in a range of 0.8 to 1.2.

7. A light source apparatus comprising.
a light source unit configured to emit light of a first wavelength;
a collection optical system configured to collect the light of the first wavelength from the light source unit;
a first fluorescent element and a second fluorescent element each configured to convert at least part of the light of the first wavelength collected by the collection optical system into light of a second wavelength that is different from the first wavelength; and
a light amount adjustment unit configured to adjust an amount of light emitted to each of the first fluorescent element and the second fluorescent element,
wherein the collection optical system irradiates the first fluorescent element with the light of the first wavelength at a first light density, and irradiates the second fluorescent element with the light of the first wavelength at a second light density that is different from the first light density.

8. A light source apparatus according to claim 7,
wherein the second light density is smaller than the first light density, and
wherein the light amount adjustment unit adjusts the amount of light so that a first amount of light emitted to the first fluorescent element is larger than a second amount of light emitted to the second fluorescent element.

9. A light source apparatus according to claim 7,
wherein when in the light of the second wavelength acquired by conversion in the first fluorescent element, I2_{λ530 nm} represents an intensity of light of 530 nm, and I2_{λ610 nm} represents an intensity of light of 610 nm, and in the light of the second wavelength acquired by conversion in the second fluorescent element. I3_{λ530 nm} represents an intensity of light of 530 nm, and I3_{λ610 nm} represents an intensity of light of 610 nm, a value of (I2_{λ630 nm}/I2_{λ610 nm})/(I3_{λ530 nm}/I3_{λ610 nm}) is in a range of 0.8 to 1.2.

10. A light source apparatus comprising:
a tight source unit configured to emit light of a first wavelength:
a splitting unit configured to split the light from the light source unit;
a fluorescent element configured to convert at least part of the light of the first wavelength into light of a second wavelength that is different from the first wavelength;
a diffusion element configured to diffuse the light of the first wavelength; and
a light amount adjustment unit configured to adjust an amount of light emitted to each of the fluorescent element and the diffusion element,
wherein the splitting unit irradiates each of the fluorescent element and the diffusion element with part of the light of the first wavelength from the light source unit at a first distribution ratio, and irradiates each of the fluorescent element and the diffusion element with at least pan of remaining light of the first wavelength from the light source unit at a second distribution ratio that is different from the first distribution ratio.

11. The light source apparatus according to claim 8,
wherein the second distribution ratio is smaller than the first distribution ratio, and
wherein the light amount adjustment unit adjusts the amount of light so that among light split by the splitting unit, light split at the first distribution ratio is larger than light split at the second distribution ratio.

12. An image projection apparatus comprising:
a light source apparatus according to claim 1; and
a light modulation element configured to modulate light from the light source apparatus.

13. An image projection apparatus comprising:
a light source apparatus according to claim 7; and
a light modulation element configured to modulate light from the light source apparatus.

14. An image projection apparatus comprising:
a light source apparatus according to claim 10; and
a light modulation element configured to modulate light from the light source apparatus.
